(19) United States
(12) Patent Application Publication
(10) Pub. No.: US 2014/0030469 A1
(43) Pub. Date: Jan. 30, 2014

(54) Structural Material and Method of Manufacturing Thereof

(71) Applicants: Marten Luinstra, Vinkenbuurt (NL); Peter Verschut, Almelo (NL)

(72) Inventors: Marten Luinstra, Vinkenbuurt (NL); Peter Verschut, Almelo (NL)

(21) Appl. No.: 13/992,565

(22) PCT Filed: Dec. 9, 2011
(86) PCT No.: PCT/NL2011/050842

§ 371 Date: Oct. 15, 2013

(30) Foreign Application Priority Data
Dec. 9, 2010 (NL) 2005845

(51) Int. Cl. B32B 3/18; B32B 3/26

(52) U.S. Cl. CPC B32B 3/18; B32B 3/26
USPC 428/71; 428/138; 156/191; 156/242; 156/78

(57) ABSTRACT

The invention relates a structural material suitable for constructing load bearing structures such as truck mountable dumper or tipper bodies, tanks, ship hulls, containers and the like, comprising a first layer of fibre reinforced thermoplastic or thermoset material; a space frame structure of fibre reinforced thermoplastic or thermoset material; a second layer of fibre reinforced thermoplastic or thermoset material; wherein the space frame structure is arranged in between and affixed to the first and the second layer.

The invention further relates to a method of manufacturing a structural material.

The invention relates to a structural material and a method of manufacturing thereof.

More specifically, the invention relates to a composite structural material suitable for heavy duty applications such as truck mounted dumpers or tippers and the method for manufacturing such composite structural material.

In the art, these kind of composite materials are proposed for e.g. vehicle bodies, such as for example in the international application WO94/26576. In this application, thermoplastic sandwich material is used, wherein a layer of foamed recycled material is sandwiched between two layers of virgin thermoplastic material. In this application the layers are built up by means of e.g. rotational moulding of linear low density polyethylene.

These materials are however relative weak, and have a low glass transition and low melting temperature. For these reasons, the application of these materials is unpractical, and even dangerous with respect to flammability. Furthermore the specific local strength and direction of the fibres is very difficult to monitor and adapt.

In the European patent application EP1340669 a dumper or tipper is described, comprising a resin transfer moulded fibre reinforced body, being reinforced with foam shaped trusses.

This structure however is not suitable for high temperature applications and has a poor impact resistance. Furthermore the proposed method of manufacturing is difficult to transform in automatic or robotic manufacturing. Thus this method is less suitable for mass production and therefore commercially less viable.

Accordingly it is an object of the invention to mitigate or solve the above described and/or other problems of structural materials in the art, while maintaining and/or improving the advantages thereof.

More specifically the object of the invention can be seen in providing a strong structural material, which can withstand high loads, high stresses, high temperature differences, high impacts and which has a high chemical resistance while being considerably less heavy than usual structural materials such as steel without losing structural integrity.

These and/or other objects are reached by a structural material suitable for constructing load bearing structures such as truck mountable dumper or tipper bodies, tanks, ship hulls, containers and the like, comprising a first layer of fibre reinforced thermoplastic or thermoset material; a space frame structure of fibre reinforced thermoplastic or thermoset material; a second layer of fibre reinforced thermoplastic or thermoset material; wherein the space frame structure is arranged in between and affixed to the first and the second layer.

Thus a durable and strong material is obtained, which can be used for producing e.g. tipper bodies for tipper or dumper trucks. Since the structural material of the invention is lighter than steel, a tipper body produced from this material can carry a higher payload.

The space frame structure of the structural material between the first and second layer can comprise open spaces. Thus a light weight, strong and stiff construction can be obtained. The open spaces in the space frame can be filled with a foam material. Thus the material can be isolated and can even have an increased structural integrity. The foam can be inserted as a solid foam in the open spaces during the built up of the material or it can be injected after completion of the first and second layers.

In the structural material, the fibre reinforced first layer, the fibre reinforced second layer and/or the components of the space frame can be manufactured by being wound or arranged by means of local tape or fibre placement on a preform or mould as a fibre comprising elongated thermoplastic or thermoset material such as tape, unidirectional tape, thread, comingled fibre, cable, woven or non woven ribbon.

Thus large parts of the manufacturing can be performed automatically, reducing the labour costs and efforts involved.

In the structural material, the fibre comprising elongated thermoplastic or thermoset material can be welded, fused, bound or molten during or after winding on the perform or mould.

Preferably, the fibre reinforced thermoplastic or thermoset material of the first layer, the second layer and/or the space frame is resistant to temperatures up to 150° C., preferably up to 175° C. and more preferably to 200° C. In this way the tipper body may be used for transporting relatively high temperature materials, like e.g. hot asphalt. By applying this technique, a direction of the fibres and thus directionally composed strength can be arranged. As described hereinabove, the structural material can be integrated in a tipper body or dumper body mountable on e.g. a truck.

The invention further related to a method of manufacturing a structural material according to claim 1, wherein the method comprises the following steps, to be performed in any suitable order; a) providing a first perform or mould; b) winding or arranging by means of local tape or fibre placement a first elongated thermoplastic or thermoset material comprising fibre material on the first perform or mould; c) fusing, bonding, welding or melting the first elongated thermoplastic or thermoset material during or after step b) to produce a first layer; d) providing a space frame structure by welding or bonding together fibre reinforced beams and trusses; e) arranging the space frame on, in or around the first layer and welding or bonding the space frame to the first layer; f) arranging a second layer on, in or around the space frame, such that the space frame is arranged between the first and the second layer.

By this method an automated build up of most of the components can be performed, while strong and directionally arranged strength of each individual component can be designed and made. In this method, step f) can comprise the following steps, to be executed in any suitable order: g) providing a second perform or mould; h) winding or arranging by means of local tape or fibre placement a second elongated thermoplastic or thermoset material comprising fibre material on the second perform or mould; i) fusing, bonding, welding or melting the second elongated thermoplastic material during or after step h) to produce a second layer; j) removing the second layer from the second preform or mould and arranging it in, on or around the space frame.

The first and/or the second preform or mould can provide at least two sites for producing at least two of the first and/or the second layers in one winding or tape or fibre laying step b) and/or h), after which in a subsequent cutting step, the at least two first and/or second layers can be cut from each other and from eventual residual material. By combining the moulds for the first and second layers an efficient winding or tape laying process is achieved.

Thus a relative flexible production of the different individual layers can be performed. Multiple layers can be formed in one step, for instance two first and two second layers, allowing the parts for two separate products to be made in one process cycle. Also different parts of one product may be made, e.g. a set of first and second layers for forming a tipper body and another set of layers for forming a hatch.

The above described method can further comprise: providing a foam material during or after step e), f) or g) in the open spaces of the space frame, by inserting solid foam parts in the open spaces before arranging and affixing the second layer to the space frame or by injecting a curable foam material into the open spaces after arranging and affixing the second layer to the space frame. The foam provides additional strength and rigidity, and further provides isolation. This latter feature is advantageous when the structural material is used in a container or tipper body that is filled with contents having temperature that is higher or lower than ambient temperature.

Additional layers can be affixed to the first and/or the second layer, chosen from isolating or structural non-reinforced or reinforced materials such as aerogel, PEEK, Teflon, nylon, polyamide, polyimide, and/or other suitable materials, wherein the additional layers can be coated or formed on the first and/or second layer or can be formed on a third mould or preform in advance, and hereafter affixed to the first or the second layer by bonding, welding or melting such that a multilayer is obtained.

The space frame in step e) can be constructed from beams and trusses, wherein at least a portion of the beams and trusses are wound from a third elongated thermoset or thermoplastic fibre comprising material, wherein the third elongated material is fused, welded, bonded or melted together during or after winding and wherein the beams and trusses are welded or bonded together into said space frame.

The fibre reinforced thermoplastic or thermoset material of the first layer, the second layer and/or the space frame is resistant to temperatures up to 150° C., preferably up to 175° C. and more preferably to 200° C., so as to provide a high temperature resistant product.

The first layer and/or the second layer can be formed as an open box having a bottom segment and a plurality of walls extending from said bottom segment.

The method of manufacturing can be performed as a fully automated production. By this way, an economically viable manufacturing can be established.

The invention also relates to a tipper body comprising a bottom section, two side walls and at least one end wall. In accordance with the invention, each part of the tipper body is made from a structural material as described above.

In order to further elucidate the invention, exemplary embodiments will be described with reference to the drawing. In the drawing:

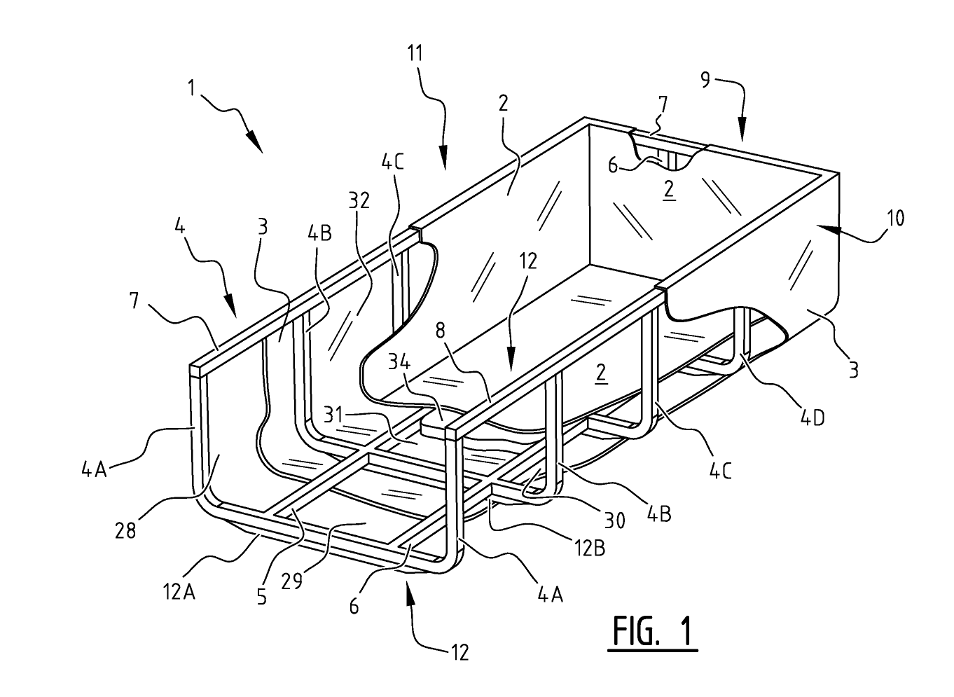

FIG. 1 depicts a schematic perspective view of a first embodiment of the structural material according to the invention;

FIG. 2 depicts a schematic perspective view of a mould or preform according to an embodiment of the invention;

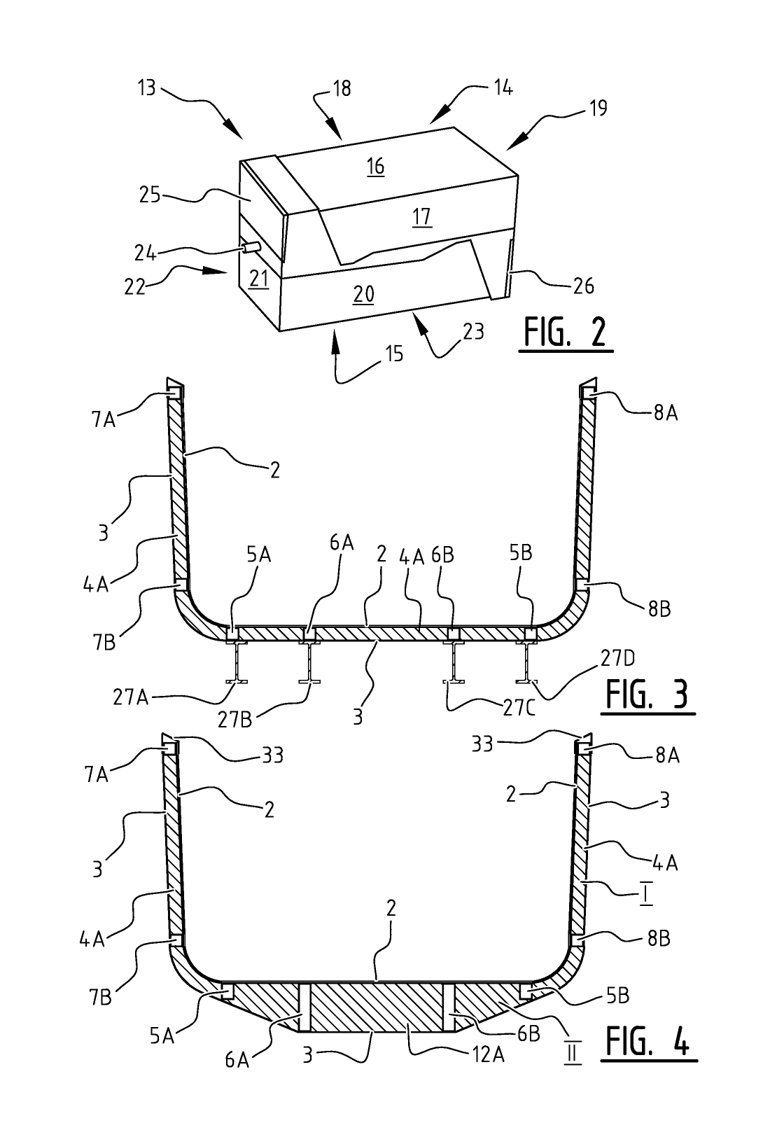

FIG. 3 depicts a schematic cross sectional view of the structural material;

FIG. 4 depicts a schematic cross sectional view of the structural material according to an alternative embodiment.

The figures represent specific exemplary embodiments of the inventions and should not be considered limiting the invention in any way or form. Throughout the description and the figures the same or corresponding reference numerals are used for the same or corresponding elements.

The expression “fibre” used herein is to be understood as, though not to be considered limited to any material with an enhanced tensile strength, which can be embedded in a thermoplastic or thermoset material. Examples of such materials are carbon fibres, glass fibres, other mineral fibres, metal fibres, yarns, or threads of any combination of these fibres.

The expression “tipper or dumper body” used herein is to be understood as, though not to be considered limited to a open box like structure, that can be mounted on a truck, and can be tipped over, in order to empty.

The expression “space frame structure” used herein is to be understood as, though not to be considered limited to an open structural mostly three dimensional frame.

In FIG. 1, a schematic perspective view is depicted of a structural material 1 for a dumper or tipper body. The dumper or tipper body includes a bottom section 12, first and second side walls 10, 11 and a front end wall 9. The tipper body has an open top and an open rear end opposite the front end wall 9. This open rear end may be closed off by a hatch (not shown) that can be hingedly arranged between the side walls 10, 11. This hatch can be made from a similar structural material.

The structural material 1 comprises an inner first layer 2, a space frame 4 and an outer second layer 3. The space frame is arranged or sandwiched between the first and second layer. The space frame 4 is built up from beams 5, 6 7 and 8 and trusses 4A, 4B, 4C and 4D. The trusses 4A-4D are U-shaped hollow or foam filled fibre reinforced tubes. The trusses 4A-4D can run from the first side wall 11 via the bottom section 12 to the second side wall 10. At the bottom section 12, the trusses 4A-4D may be provided with a broadened section 12A-12D respectively, for further reinforcement, as can be seen in detail in FIG. 4. The trusses 4A-4C can be made by providing a foam material having a similar shape, around which a fibre comprising elongated thermoplastic or thermoset material is wound.

The fibre comprising elongated material can for instance be a tape, a unidirectional tape, a thread, comingled fibre material, a cable, or a woven or a nonwoven ribbon. This material can be affixed to itself during or after winding. During winding, the attachment can be done for instance by local heating by means of e.g. a laser, or other light, heat or infrared source. Thus the fibre material can be wound in certain directions, such that optimal strength distribution within the trusses can arranged.

The fibre comprising elongated material can be a thermoset material such as an epoxy resin, a phenol resin or a vinylether resin.

The fibre comprising elongated material can also be a thermoplastic material such as an engineering plastic, chosen from one or more of PETP, PET, PA, PBTP, PEEK, POM, PPS, ABS, PES, PEKK and or other suitable polymers.

The thermoset or thermoplastic material is preferably a material having a glass transition temperature T_{g} of more than 300° C. In that way the structural material can be highly temperature resistant up to temperatures in the order of 150-200° C., so that the resulting product can be used in a high temperature environment. For instance, the tipper body made of this material may be used for transporting hot asphalt to a road construction side.

The applied fibres can be glass fibres, quarts glass fibres, carbon fibres, any other mineral fibre, or other suitable fibres.

The inner first layer and the outer second layer can be wound in a similar way and form similar materials, although the form or mould around which these are wound is different. In FIG. 2, such a mould or preform is depicted.

The mould or perform 13 is a boxlike structure, provided with an axis 24, around which the mould 13 can be rotated. Two spaces 14 and 15 are provided where a first 2 and/or a second layer 3 can be produced. The space 14 comprises a bottom section 16, two side wall sections 17 and 18 and a front wall section 19. Similarly, the space 15 provides a front wall section 21, two side wall sections 22 and 23 and a bottom wall section 23. In this way the spaces 14, 15 are similarly shaped, but have different dimensions to form a second or outer layer 3 that will fit around the first or inner layer 2 and the space frame 4.

In order to manufacture the first 2 and/or the second layer 3, the mould 13 is rotated around the axis 24 and a ribbon of fibre reinforced material is wound around the mould 13. A winding device or tape or fibre placement device that is used to place and/or wind the elongated material can comprise a reel with winding material such as e.g. ribbon or tape, a feeding guide and a heating gun. The device or at least its feeding guide can be moveable parallel to the axis 24 between the front wall sections 19, 21 of the mould 13. The heating gun can be a hot air gun, a laser, or an infra red source. The tape or the ribbon can be directly welded or fused on the mould or on a previous layer by heating the tape before it touches the mould or the previous layer, during it is touching the mould or the previous layer or directly after it has touched the mould or the previous layer.

Alternatively, the elongated material can be added on the mould or the underlying layers by tape or fibre placement. Thus the elongated material is cut, such that the amount of excess material is reduced to a minimum and the cutting loose of the separate structural parts is no longer necessary.

Alternatively, the ribbon or tape can also be cured afterwards, for example by inserting the complete mould with the wound material in an oven.

In FIG. 2, the mould 13 is provided with two spaces for two firsts and or second layers. The mould in this figure is further provided with two spaces 25 and 26 for the backside hatch of the tipper or dumper body. Alternatively the mould can comprise four places for four first 2 and/or second layers 3, to be wound and produced in one step. Such a mould is considerably longer than the mould which is schematically depicted in FIG. 2.

After the first 2 and/or second layer 3 are manufactured, they are cut loose from each other and eventual excess material is cut off. Each layer 2, 3 will have a shape corresponding to that of the relevant mold space 14, 15, including a bottom, two side walls and a front wall. The layers 2, 3 are positioned at, on or in the space frame 4 and affixed thereto by welding, bonding, fusing, gluing or the like, thus forming an open topped box-like structure.

In similar fashion the layers formed in the spaces 25, 26 are cut loose and affixed to a corresponding space frame to form a hatch that may be mounted in the open rearside of the box-like structure.

The space frame 4 as is depicted in FIG. 1 comprises empty spaces 28, 29, 30, 31 and 32. These empty spaces can be filled with foam 34, either before the first 2 and second layer 3 are attached to the space frame 4 as solid block like pieces, fitting in the empty spaces 28-32 or afterwards as a foam curing fluid.

The beams 5, 6, 7 and 8 are, similar to the trusses 4A-4C manufactured from a fibre reinforced material. The beams 5-8 can be shifted through predefined holes in the trusses 4A-4D, as can be seen in more detail in FIG. 3. In this figure in truss 4A, the beams 6A, 6B, 7A, 7B, 8A and 8B are inserted. Alternatively the trusses 4A-4D can be interrupted and attached to the beams 6A-8B, e.g. by knee joints and/or corner linings. In a further alternative, the trusses 4A-4D and the beams 6A-8B can cross, wherein at the intersections recesses can be provided for a smooth crossing.

The beams 6A-8B can be made as hollow tubes, core filled tubes, or open T-, L-, I-, U-shaped profiles or other suitable profiles. In a similar way, the trusses 4A-4D can have any of these profile shapes.

In FIG. 3, the outer layer 3 is draped around the beams 6A-8B and the trusses 4A-4D. Below the outer layer 3, additional reinforcing profiles 27A, 27B, 27C and 27D can be provided. In the alternative embodiment as shown in FIG. 4, the reinforcing profiles 27A-27D are left out, and the lower beams 5A, 5B, 6A and 6B are having a enlarged height. The trusses 4A-4D are provided with an stronger bottom section 12A-12D respectively, In the 12A-12D again holes are provided for inserting the beams 5A-8B. The outer layer 3 is affixed to the outer side of the outer side of the bottom sections 12A-12D, and as such a more rigid construction can be provided.

In between the beams 6A and 6B, a frame can be mounted to which the tipper arm or tipper cylinder can be mounted. Since this frame can be integrated with the tipper body, a strong and durable attachment point can be provided. The attachment of the hinges of the tipper body can similarly be integrated with the tipper body, e.g. with the space frame.

In FIGS. 3 and 4, at the upper edge of the tipper body, beams 7A and 8A are provided, these beams can be L-shaped, running horizontally from the mid front end portion 9, along the side portions 10 or 11 towards the open rear end of the tipper body. Similarly the beams 5 and 6 can be L-shaped, running down from the upper edge of the front end section 9, via the bottom section 12 towards the rear edge of the tipper body.

On top of the outer edge of the front end portion 9 and on top of the side wall portions 10 and 11 a protective collar 33 can be arranged. This collar can close and seal of the outer edges, where the first 2 and second layer 3 meet, such that e.g. water is prevented from reaching the inner structure of the structural material 1.

In FIGS. 3 and 4, the inner layer 3 is built up out of two or more layers. The innermost of these layers can be a chemical barrier, a heat resistant material or a shock and/or impact absorbing material such as e.g. nylon, Teflon, PEEK or any other relative inert material. Another material as inner layer can comprise PUR for its shock and/or impact absorbing properties. The lining can also be chosen to have a low surface friction, such that the load of the tipper body can be unloaded more rapidly and/or smoothly. The applied materials as additional layers can be non-reinforced or reinforced.

The additional layer can further be a protective or isolating layer, such as aerogel or similar material. Any additional layer can on its turn be manufactured as depicted in FIG. 2 and described hereinabove and can after its completion be placed and bonded or glued in on or around the underlying layer 2, 3 or any other layer. These additional layers can, during the service life of the material be replaced, while the structure remains intact.

The invention is to be understood not to be limited to the exemplary embodiments shown in the figures and described in the specification. For instance the structural material can be used as concrete mould material, in construction of houses, industrial buildings and or other civil structures.

In some applications a second space frame might be used, for further strengthening.

These and other modifications are considered to be variations that are part of the framework, the spirit and the scope of the invention outlined in the claims.

### LIST OF REFERENCE SIGNS

1. Structural material

2. First layer

3. Second layer

4. Space frame

5. Beam

6. Beam

7. Beam

8. Beam

9. Front end portion

10. Side end portion

11. Side end portion

12. Bottom portion

13. Mould

14. First mould place

15. Second mould place

16. Bottom mould portion

17. Side mould portion

18. Side mould portion

19. Front end mould portion

20. Side mould portion

21. Front end mould portion

22. Side end mould portion

23. bottom mould portion

24. Axis

25. Tail hatch mould portion

26. Tail hatch mould portion

27A-D. Reinforcement profiles

28. Open space

29. Open space

30. Open space

31. Open space

32. Open space

33. Protective collar

34. Foam

1. A structural material suitable for constructing load bearing structures such as truck mountable dumper or tipper bodies, tanks, ship hulls, containers and the like, comprising
a first layer of fibre reinforced thermoplastic or thermoset material;
a space frame structure of fibre reinforced thermoplastic or thermoset material;
a second layer of fibre reinforced thermoplastic or thermoset material;
wherein the space frame structure is arranged in between and affixed to the first and the second layer.

2. A structural material according to claim 1, wherein the space frame structure between the first and second layer comprises open spaces.

3. A structural material according to claim 2, wherein the open spaces in the space frame are filled with a foam material.

4. A structural material according to claim 3, wherein the foam is inserted as a solid foam in the open spaces during the built up of the material or injected after completion of the first and second layers.

5. A structural material according to claim 1, wherein the fibre reinforced first layer, the fibre reinforced second layer and/or the components of the space frame are wound or arranged by means of local tape or fibre placement on a preform or mould as a fibre comprising elongated thermoplastic or thermoset material such as tape, unidirectional tape, thread, comingled fibre, cable, woven or nonwoven ribbon.

6. A structural material according to claim 5, wherein the fibre comprising elongated thermoplastic or thermoset material is welded, fused, bound or molten during or after winding on the perform or mould.

7. A structural material according to claim 1, wherein the fibre reinforced thermoplastic or thermoset material of the first layer, the second layer and/or the space frame is resistant to temperatures up to 150° C., preferably up to 175° C. and more preferably up to 200° C.

8. A structural material according to claim 1, wherein the structural material is integrated in a tipper body or dumper body mountable on e.g. a truck.

9. A method of manufacturing a structural material according to claim 1, wherein the method comprises the following steps, to be performed in any suitable order;
a) providing a first perform or mould;
b) winding or arranging by means of tape or fibre placement a first elongated thermoplastic or thermoset material comprising fibre material around the first perform or mould;
c) fusing, bonding, welding or melting the first elongated thermoplastic or thermoset material during or after step b) to produce a first layer;
d) providing a space frame structure by welding or bonding together fibre reinforced beams and trusses;
e) arranging the space frame on, in or around the first layer and welding or bonding the space frame to the first layer;
f) arranging a second layer on, in or around the space frame, such that the space frame is arranged between the first and the second layer.

10. The method according to claim 9, wherein step f) comprises the following steps, to be executed in any suitable order:
g) providing a second perform or mould;
h) winding or arranging by means of tape or fibre placement a second elongated thermoplastic or thermoset material comprising fibre material around the second perform or mould;
i) fusing, bonding, welding or melting the second elongated thermoplastic material during or after step h) to produce a second layer;
j) removing the second layer from the second preform or mould and arranging it in, on or around the space frame.

11. Method according to claim 10, wherein the first and/or the second preform or mould provide at least two sites for producing at least two of the first and/or the second layers in one winding or tape or fibre laying step b) and/or h), after which in a subsequent cutting step, the at least two first and/or second layers can be cut from each other and from eventual residual material.

12. Method according to claim 10, further comprising:
providing a foam material during or after step e), f) or g) in the open spaces of the space frame, by inserting solid foam parts in the open spaces before arranging and affixing the second layer to the space frame or by injecting a curable foam material into the open spaces after arranging and affixing the second layer to the space frame.

13. Method according to claim 9, wherein additional layers can be affixed to the first and/or the second layer, chosen from isolating and structural materials such as aerogel or other isolating and/or nonwoven material, PEEK, Teflon, polyamide, polyimide, PETP, FBTP, POM, PU or PU-like materials;
wherein the additional layers can be coated or formed on the first and/or second layer or can be formed on a third mould or preform in advance, and hereafter affixed to the first or the second layer by bonding, welding or melting such that a multilayer is formed.

14. Method according to claim 9, wherein the space frame in step e) is constructed from beams and trusses, wherein at least a portion of the beams and trusses are wound from a third elongated thermoset or thermoplastic fibre comprising material, wherein the third elongated material is fused, welded, bonded or melted together during or after winding and wherein the beams and trusses are welded or bonded together into said space frame.

15. Method according to claim 9, wherein the fibre reinforced thermoplastic or thermoset material of the first layer, the second layer and/or the space frame is resistant to temperatures up to 150° C., preferably up to 175° C. and more preferably up to 200° C.

16. Method according to claim 9, wherein the first layer and/or the second layer is formed as an open box having a bottom segment and a plurality of walls extending from said bottom segment.

17. Method according to claim 9, wherein substantially all steps are performed in an automated process.

18. Tipper body, comprising a bottom section, two side walls and at least one end wall, each of which are made from a structural material according to claim 1.

19. Tipper body according to claim 18, further comprising a frame for attachment of a tipper arm or tipper cylinder, which frame is integrally formed with the tipper body.
